(19) United States
(12) Patent Application Publication
(10) Pub. No.: US 2024/0039713 A1
(43) Pub. Date: Feb. 1, 2024

(54) QKD APPARATUS, QKD SYSTEM, QKD START CONTROL METHOD, AND COMPUTER PROGRAM PRODUCT

(71) Applicant: Kabushiki Kaisha Toshiba, Tokyo (JP)

(72) Inventor: Yoshimichi TANIZAWA, Yokohama Kanagawa (JP)

(73) Assignee: Kabushiki Kaisha Toshiba, Tokyo (JP)

(21) Appl. No.: 18/179,459

(22) Filed: Mar. 7, 2023

(30) Foreign Application Priority Data
Jul. 27, 2022 (JP) 2022-119667

(51) Int. Cl. H04L 9/08

(52) U.S. Cl. CPC H04L 9/0858

(57) ABSTRACT

According to an embodiment, a quantum key distribution (QKD) apparatus includes one or more hardware processors configured to: perform inter-QKD-apparatus connection authentication indicating authentication processing with an opposing QKD apparatus, and key manager (KM)-QKD connection authentication indicating authentication processing with an opposing KM apparatus; and enable a QKD function in a case where the inter-QKD-apparatus connection authentication is successful and the KM-QKD connection authentication is successful.

### CROSS-REFERENCE TO RELATED APPLICATIONS

This application is based upon and claims the benefit of priority from Japanese Patent Application No. 2022-119667, filed on Jul. 27, 2022; the entire contents of which are incorporated herein by reference.

### FIELD

Embodiments described herein relate generally to a quantum key distribution (QKD) apparatus, a QKD system, a QKD start control method, and a computer program product.

### BACKGROUND

Hitherto, a quantum key distribution (QKD) technology for securely sharing a cryptographic key by using a single photon continuously transmitted between a transmission apparatus and a reception apparatus connected by an optical fiber has been known. It is ensured, based on the principle of quantum mechanics, that the cryptographic key generated and shared by the quantum key distribution (QKD) technology is not wiretapped.

### BRIEF DESCRIPTION OF THE DRAWINGS

FIG. 1 is a diagram illustrating a first example of a apparatus configuration of a quantum key distribution (QKD) system according to an embodiment;

FIG. 2 is a diagram for explaining functions of a management system according to the embodiment;

FIG. 3 is a diagram illustrating a second example of the apparatus configuration of the QKD system according to the embodiment;

FIG. 4 is a diagram illustrating an example of a functional configuration of a QKD apparatus according to the embodiment;

FIG. 5 is a sequence diagram illustrating an example of QKD apparatus-management system connection authentication according to the embodiment;

FIG. 6 is a sequence diagram illustrating an example of key manager (KM)-QKD connection authentication according to the embodiment;

FIG. 7 is a sequence diagram illustrating a first example of inter-QKD-apparatus connection authentication according to the embodiment;

FIG. 8 is a sequence diagram illustrating a second example of the inter-QKD-apparatus connection authentication according to the embodiment; and

FIG. 9 is a diagram illustrating an example of a hardware configuration of the QKD apparatus according to the embodiment.

### DETAILED DESCRIPTION

According to an embodiment, a quantum key distribution (QKD) apparatus includes one or more hardware processors configured to: perform inter-QKD-apparatus connection authentication indicating authentication processing with an opposing QKD apparatus, and key manager (KM)-QKD connection authentication indicating authentication processing with an opposing KM apparatus; and enable a QKD function in a case where the inter-QKD-apparatus connection authentication is successful and the KM-QKD connection authentication is successful.

Exemplary embodiments of a quantum key distribution (QKD) apparatus, a QKD system, a QKD start control method, and a computer program product will be explained below in detail with reference to the accompanying drawings.

### First Embodiment

Key sharing by QKD has a limited communicable distance in principle, and only one-to-one key sharing can be used. A key manager (KM) apparatus is introduced in addition to the QKD apparatus, and the KM apparatus holds and manages the key and is configured to relay the key, whereby a QKD network can be configured. As a result, in a network in which the QKD is used as a link and the KM apparatus is used as a node, cryptographic key sharing between arbitrary two bases can be realized (see JP 2016-171530 A and ITU-T Y.3800, (online), (searched on May 20, 2022), Internet<URL:https://www.itu.int/rec/T-REC-Y.3800/en>).

The shared cryptographic key is provided from the KM apparatus to an external application and used. The QKD apparatus and the KM apparatus may be integrally realized by, for example, one housing.

### Example of Apparatus Configuration

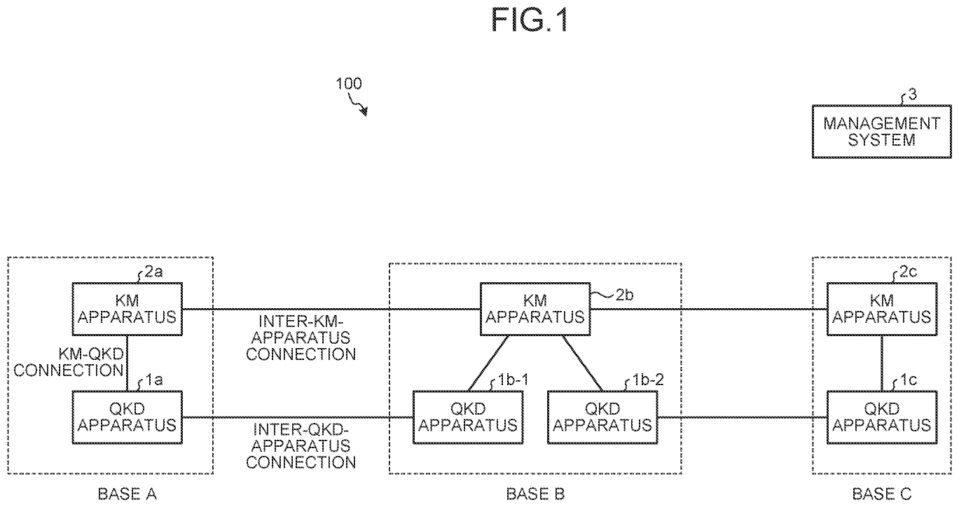

FIG. 1 is a diagram illustrating a first example of a apparatus configuration of a quantum key distribution (QKD) system 100 according to an embodiment. The QKD system 100 according to the embodiment includes QKD apparatuses 1a to 1c, KM apparatuses 2a to 2c, and a management system 3. In a case where the QKD apparatuses 1a to 1c are not distinguished from each other, the QKD apparatuses 1a to 1c are simply referred to as QKD apparatus 1. Similarly, in a case where the KM apparatuses 2a to 2c are not distinguished from each other, the KM apparatuses 2a to 2c are simply referred to as KM apparatus 2.

The QKD apparatus 1 executes a QKD protocol with the opposing QKD apparatus 1 by QKD as described above to generate a cryptographic key. The cryptographic key is provided to the KM apparatus 2.

The KM apparatus 2 receives the cryptographic key from at least one QKD apparatus 1. The KM apparatus 2 holds and manages the cryptographic key and relays the cryptographic key between the KM apparatuses 2, thereby realizing cryptographic key sharing between arbitrary KM apparatuses 2. Note that details of the relaying are described in JP 2016-171530 A, ITU-T Y.3800, (online), (searched on May 20, 2022), Internet<URL:https://www.itu.int/rec/T-REC-Y.3800/en>, and the like.

The management system 3 manages a state and a configuration of the QKD network configured by the QKD apparatus 1 and the KM apparatus 2.

Bases A to C are places where the QKD apparatuses 1 and the KM apparatuses 2 are installed. Nodes implemented by the QKD apparatus 1 and the KM apparatus 2 may be referred to as trusted nodes. The bases A to C are assumed to be sections in which physical safety is ensured, thereby ensuring security in storage and relaying of the cryptographic key.

Note that an application using the cryptographic key is connected to the KM apparatus 2, receives the cryptographic key from the KM apparatus 2, and performs cryptographic communication by using the cryptographic key. In many cases, the application is installed in the bases A to C. In addition, the management system 3 is generally installed in an independent base (trusted node) or installed in any base (for example, the base C or the like in the example of FIG. 1).

Inter-QKD-apparatus connection, inter-KM-apparatus connection, and KM-QKD connection necessary for proper connection and operation of the QKD system 100 will be described.

The inter-QKD-apparatus connection is connection between the QKD apparatuses 1, and the QKD protocol is executed by the inter-QKD-apparatus connection to generate the cryptographic key. The QKD apparatus 1 generally includes a transmitter that transmits photons and a receiver that receives photons, and operates by a specific pair. It is necessary to operate a correct QKD apparatus with a correct pair configuration.

The inter-KM-apparatus connection is, for example, connection used by the KM apparatus 2 to verify the cryptographic key acquired from the QKD apparatus 1. For example, connection between the KM apparatuses 2 is connection used to perform key relaying using the cryptographic key. Since the KM apparatus 2 handles cryptographic key data, the KM apparatus 2 itself needs to be legitimate. It is also important that the connection is intended by the KM apparatuses 2.

The KM-QKD connection is connection used when the cryptographic key generated by the QKD apparatus 1 is provided to the KM apparatus 2. At the same time, the KM-QKD connection may be used by the KM apparatus 2 (or another management entity via the KM apparatus 2) to grasp a situation of the QKD apparatus 1. The KM apparatus 2 holds, manages, relays, provides, and erases the cryptographic key generated by the QKD apparatus 1. Therefore, the KM apparatus 2 and the QKD apparatus 1 need to be legitimate apparatuses, and it is also important that the QKD apparatus 1 paired with the KM apparatus 2 is the intended QKD apparatus 1.

In addition to the fact that each of the inter-QKD-apparatus connection, the inter-KM-apparatus connection, and the KM-QKD connection needs to be legitimate, a relationship therebetween is also important. Usually, it is necessary that a pair of QKD apparatuses 1 that have the inter-QKD-apparatus connection are connected to the KM apparatuses 2 in the inter-KM-apparatus connection relationship, and operates in such a way as to provide the same cryptographic key to the KM apparatuses 2 in the inter-KM-apparatus connection relationship.

For example, in the example of FIG. 1, the QKD apparatus 1a and the QKD apparatus 1b-1 have the intra-QKD-apparatus connection. The QKD apparatus 1a and the KM apparatus 2a are in the KM-QKD connection relationship. The QKD apparatus 1b-1 and the KM apparatus 2b are in the KM-QKD connection relationship. The KM apparatus 2a and the KM apparatus 2b have the intra-KM-apparatus connectionp. As described above, a state in which the QKD apparatuses 1a and 1b-1 and the KM apparatuses 2a and 2b are connected in a “quadrangular relationship” by the inter-QKD-apparatus connection, the KM-QKD connection (between the QKD apparatus 1b-1 and the KM apparatus 2b), the inter-KM-apparatus connection, and the KM-QKD connection (between the KM apparatus 2a and the QKD apparatus 1a) is a state of a correct connection relationship.

In the QKD system 100 according to the embodiment illustrated in FIG. 1 described above, it is important to ensure security. Therefore, even in the introduction (or replacement) of the QKD apparatus 1, it is required to confirm that the QKD apparatus 1 is a valid apparatus and that valid setting has been made for the QKD apparatus 1 through a valid procedure, to ensure that appropriate QKD apparatuses 1 are connected, and then to operate the QKD apparatus 1.

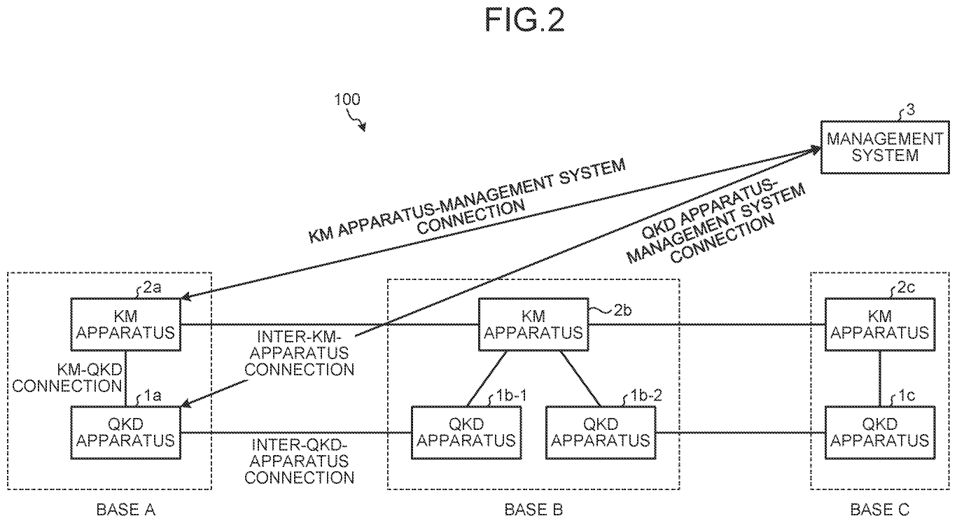

Next, connection including the management system 3 will be described with reference to FIG. 2.

FIG. 2 is a diagram for explaining functions of the management system 3 according to the embodiment. The management system 3 according to the embodiment generally performs state monitoring, setting, and the like of the QKD apparatus 1 and the KM apparatus 2. When the QKD apparatus 1 is connected to the management system 3, the management system 3 confirms that the QKD apparatus 1 is legitimate. Similarly, when the KM apparatus 2 is connected to the management system 3, the management system 3 confirms that the KM apparatus 2 is legitimate. The management system 3 verifies the validity of the QKD apparatus 1 and the KM apparatus 2 and the correctness of the setting and determines an operation permission for the QKD apparatus 1 and the KM apparatus 2 according to the verification result. In other words, the management system 3 activates the QKD apparatus 1 and the KM apparatus 2.

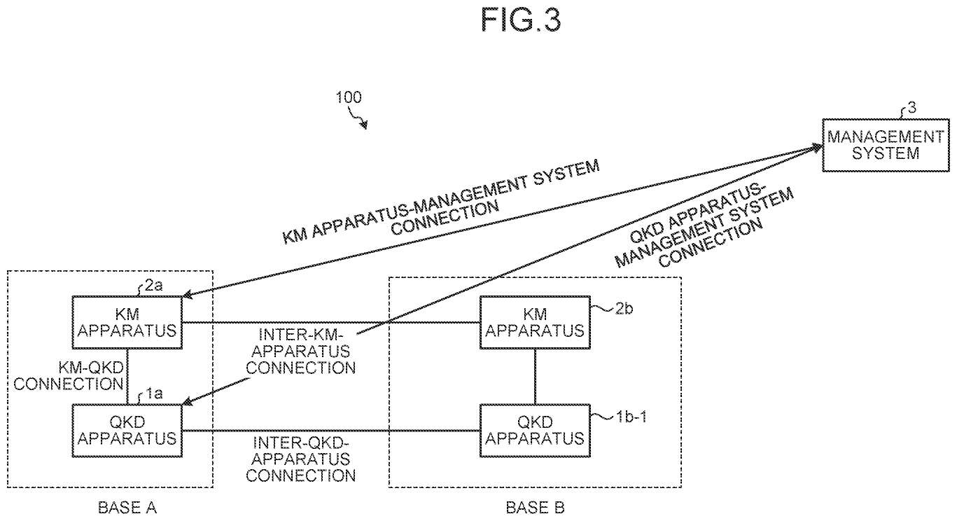

Note that the configuration of the QKD system 100 according to the embodiment is not limited to the example of FIG. 1. FIG. 3 is a diagram illustrating a second example of the apparatus configuration of the QKD system 100 according to the embodiment. In the second example of FIG. 3, the base C is not included, and the form of the system is further simplified.

In other words, connection relationships included in the system configuration of the QKD system 100 according to the embodiment are as follows, and authentication for ensuring security is required for each connection relationship.

Inter-QKD-apparatus connection authentication

Inter-KM-apparatus connection authentication

KM-QKD connection authentication

QKD apparatus-management system connection authentication

KM apparatus-management system connection authentication

In the description of the embodiment, authentication directly related to the QKD apparatus 1 (inter-QKD-apparatus connection authentication, KM-QKD connection authentication, and QKD apparatus-management system connection authentication) will be described in detail.

### Example of Functional Configuration

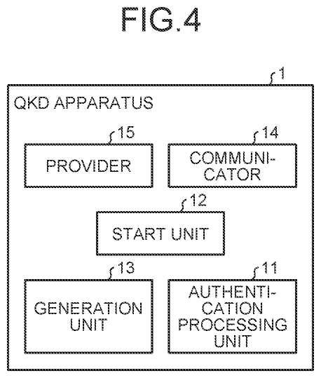

FIG. 4 is a diagram illustrating an example of a functional configuration of the QKD apparatus 1 according to the embodiment. The QKD apparatus 1 according to the embodiment includes an authentication processing unit 11, a start unit 12, a generation unit 13, a communication unit 14, and a providing unit 15.

The authentication processing unit 11 performs processing for realizing an authentication function directly related to the QKD apparatus 1. Note that details of the processing for the authentication function will be described later.

The start unit 12 performs control to enable a QKD function of the QKD apparatus 1 according to the authentication result of the authentication processing unit 11. The QKD function includes at least one of a function of generating the cryptographic key by the QKD, and a function of providing the cryptographic key to the KM apparatus 2.

A method of enabling the function of the QKD apparatus 1 includes, for example, the following variations (1) to (4), but any method may be used.

(1) Starting a synchronization operation between the QKD apparatuses 1 (for example, between the QKD apparatuses 1a and 1b-1) necessary for the operation of the QKD apparatus 1

(2) Starting quantum channel operation, that is, transmission/reception of photons

(3) Changing a key compression ratio in key distillation processing to a non-zero value to output a non-zero-sized key (that is, before authentication, the key distillation processing of the QKD is performed, but key generation is not performed by setting the key compression ratio to zero).

(4) Starting a function of providing the key to the KM apparatus 2.

The generation unit 13 generates the cryptographic key (quantum key) by the quantum key distribution, and realizes a so-called QKD protocol function. The generation unit 13 generates the cryptographic key by the QKD with the opposing QKD apparatus 1 verified to be valid by the inter-QKD-apparatus connection authentication.

The communication unit 14 has a communication function for realizing the QKD function. For example, the communication unit 14 performs transmission and reception of photons used for the quantum key distribution, transmission and reception of control information in the key distillation processing, and the like with the opposing QKD apparatus 1. For example, the communication unit 14 performs communication or the like for providing the cryptographic key (quantum key) to the KM apparatus 2. Furthermore, for example, the communication unit 14 performs communication or the like for transmitting the state of the QKD network to the management system 3.

The providing unit 15 provides the cryptographic key generated by the QKD to the KM apparatus 2. The providing unit 15 is realized by using a part of the functions of the communication unit 14. The providing unit provides the cryptographic key to the opposing KM apparatus 2 verified to be valid by the KM-QKD connection authentication.

### Basic Operation Step of Authentication Processing

Next, Variations A to C of a basic authentication operation step (authentication (or activation/validation) when the QKD apparatus 1 is introduced) in the QKD system 100 according to the embodiment will be described.

A. In a case where the inter-QKD-apparatus connection authentication and the KM-QKD connection authentication are performed and it is confirmed that both of the authentications are successful, the QKD function is activated. That is, in Variation A, the authentication processing unit 11 performs the inter-QKD-apparatus connection authentication indicating authentication processing with the opposing QKD apparatus 1 and the KM-QKD connection authentication indicating authentication processing with the opposing KM apparatus 2. Then, in a case where the inter-QKD-apparatus connection authentication is successful and the KM-QKD connection authentication is successful, the start unit 12 enables the QKD function.

A-2: In a case where the inter-QKD-apparatus connection authentication is performed and it is confirmed that the authentication is successful, the KM-QKD connection authentication including the authentication success information is performed, and in a case where it is confirmed that the authentication is successful, the QKD function is activated. Variation A-2 corresponds to activation of the QKD apparatus 1 in the KM apparatus 2, which is also validation of inter-QKD-apparatus connection and validation of KM-QKD connection.

A-3: In a case where the KM-QKD connection authentication is performed and it is confirmed that the authentication is successful, the inter-QKD-apparatus connection authentication including the authentication success information is performed, and in a case where it is confirmed that the authentication is successful, the QKD function is activated. Variation A-3 corresponds to activation in the opposing QKD apparatus 1, which is also validation of the KM-QKD connection.

B. When the inter-QKD-apparatus connection authentication, the KM-QKD connection authentication, and the QKD apparatus-management system connection authentication are performed and it is confirmed that all the authentications are successful, the QKD function is activated.

B-2. In a case where the inter-QKD-apparatus connection authentication and the KM-QKD connection authentication are performed and it is confirmed that both of the authentications are successful, the QKD apparatus-management system connection authentication including the authentication success information is performed, and in a case where it is confirmed that the authentication is successful, the QKD function is activated. That is, in Variation B-2, in a case where the inter-QKD-apparatus connection authentication is successful and the KM-QKD connection authentication is successful, the communication unit 14 transmits, to the management system 3, a request for the QKD apparatus-management system connection authentication indicating authentication processing with the management system 3 that manages the QKD system 100. Then, in a case where it is mutually verified that the QKD apparatus is valid and the management system 3 is valid by the QKD apparatus-management system connection authentication, the start unit 12 enables the QKD function. Variation B-2 corresponds to activation in the management system 3, which is also validation of the inter-QKD-apparatus connection and the KM apparatus-QKD apparatus connection.

C. In a case where the QKD apparatus-management system connection authentication is performed and it is confirmed that the authentication is successful, the inter-QKD-apparatus connection authentication and the KM-QKD connection authentication are performed according to permission of the management system 3. In a case where it is confirmed that both the inter-QKD-apparatus connection authentication and the KM-QKD connection authentication are successful, the QKD function is activated. That is, in Variation C, the communication unit 14 transmits a request for the QKD apparatus-management system connection authentication to the management system 3. Then, in a case where the QKD apparatus-management system connection authentication is successful, the authentication processing unit 11 performs the inter-QKD-apparatus connection authentication and the KM-QKD connection authentication. Variation C corresponds to a case where the management system 3 first performs activation and validation of the introduced QKD apparatus 1.

In addition to Variations A to C described above, there are various variations in the order of authentication to be performed, an entity performing the activation, a connection relationship to be a validation target, and the like, but any combination may be used.

Hereinafter, an example of a processing step for each authentication will be described in detail.

### QKD Apparatus-Management System Connection Authentication

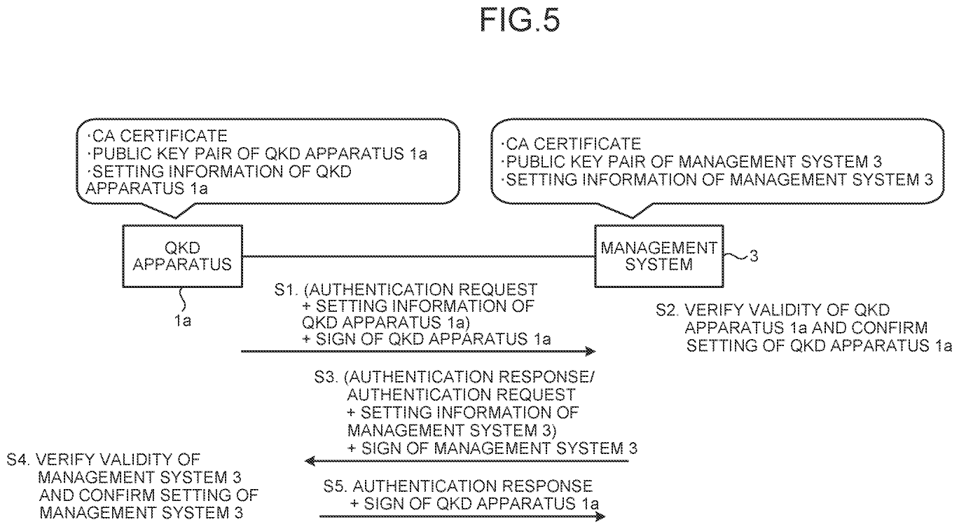

FIG. 5 is a sequence diagram illustrating an example of the QKD apparatus-management system connection authentication according to the embodiment. The example of FIG. 5 illustrates a case of an authentication sequence executed between the QKD apparatus 1a and the management system 3. It is assumed that the QKD apparatus 1a holds a certificate authority (CA) certificate, a public key/private key pair of the QKD apparatus 1a, and setting information. It is assumed that the management system 3 holds a CA certificate, a public key/private key pair of the management system 3, and setting information.

First, the communication unit 14 of the QKD apparatus 1a transmits an authentication request to the management system 3 (step S1). At this time, the authentication request may include the setting information of the QKD apparatus 1a. The setting information of the QKD apparatus 1a includes a QKD protocol of the QKD apparatus 1a, mounting information, manufacturer information, customer identifier (ID) information, IP address setting, installation position information, an operation parameter, a performance index, IP address setting of the KM apparatus 2 that provides the cryptographic key, previous authentication information, certificate information of the QKD apparatus 1a, and the like.

Note that the performance index is, for example, an assumed key distribution speed (key generation speed). In addition, for example, in a case where the QKD is already operating, the performance index may be an actual key distribution speed.

As for the authentication result, if connection of the QKD appartus 1a to the QKD apparatus 1b-1 or the KM apparatus 2a has already been authenticated, authentication result information indicating the authentication may be added to the authentication request.

In addition, an authentication request message may be added with sign information indicating that the authentication request is signed by the QKD appartus 1a and is not falsified and that it is guaranteed that the authentication request has been transmitted by the legitimate QKD appartus 1a.

Next, the management system 3 performs authentication of the QKD appartus 1a (step S2). For example, in the authentication in step S2, it is verified whether or not the QKD appartus 1a is a legitimate apparatus having a valid certificate. Further, for example, in the authentication in step S2, it is verified whether or not the setting of the QKD appartus 1a is allowed. Note that the management system 3 may hold the allowable setting information of the QKD appartus 1a in advance. In addition, for example, in the authentication in step S2, it is verified whether or not the QKD apparatus la has completed authentication (for example, the KM-QKD connection authentication or the like) to be completed in advance. In addition, for example, in the authentication in step S2, it is verified whether or not the KM apparatus 2 that is a connection authentication destination of the QKD appartus 1a is the KM apparatus 2a (it may also be separately verified whether or not the above-described “quadrangular relationship” can be confirmed with reference to the information held by the management system 3). Furthermore, for example, in the authentication in step S2, since the setting information of the QKD appartus 1a also includes the performance index, whether or not the authentication can be performed may be determined based on the sufficiency of performance.

Next, the management system 3 transmits an authentication response (the authentication processing result of step S2)/authentication request to the QKD appartus 1a (step S3). At this time, the authentication response/authentication request may include the setting information of the management system 3.

The setting information of the management system 3 includes a management protocol supported by the management system 3, mounting information, manufacturer information, customer ID information, IP address setting, installation position information, network information, configuration, and the like. Examples of the network information include a domain name system (DNS), a network time protocol (NTP), QKD network (QKDN) setting, and the like.

The authentication response/authentication request may include setting information instructing the QKD appartus 1a to perform setting. Examples of the setting information instructing the QKD appartus 1a to perform setting include setting information (for example, IP address setting, an operation parameter, IP address setting of the KM apparatus 2a that provides the cryptographic key, and the like) to be set by the QKD appartus 1a.

Furthermore, in a case where it is not verified in the authentication of step S2 that the QKD appartus 1a is connected to the KM apparatus 2a, the authentication response/authentication request may include information instructing the QKD appartus 1a to be connected to the KM apparatus 2a or instructing the QKD appartus 1a to perform authentication of connection to the KM apparatus 2a.

In addition, an authentication response/authentication request message may be added with sign information indicating that the authentication response/authentication request is signed by the management system 3 and is not falsified and that it is guaranteed that the authentication response/authentication request has been transmitted by the legitimate management system 3.

Next, the authentication processing unit 11 of the QKD appartus 1a performs authentication of the management system 3 (step S4). For example, in the authentication in step S4, it is verified whether or not the management system 3 is a legitimate apparatus having a valid certificate. In addition, for example, in the verification in step S4, it is verified whether or not the setting of the management system 3 is allowable (whether or not network information (setting) of the management system 3 is appropriate). The authentication processing unit 11 may perform the authentication in step S4 after verifying whether or not the setting information indicated by the management system 3 for the QKD appartus 1a is allowable.

Next, the communication unit 14 transmits an authentication response (the authentication processing result of step S4) to the management system 3 (step S5). An authentication response message may be added with sign information indicating that the authentication request is signed by the QKD appartus 1a and is not falsified and that it is guaranteed that the authentication request has been transmitted by the legitimate QKD appartus 1a.

In a case where the QKD apparatus-management system connection authentication in steps S1 to S5 is successful, the QKD appartus 1a performs any one or more of the following processings (1) to (3).

(1) The QKD appartus 1a reflects the setting indicated by the management system 3.

(2) The authentication processing unit 11 of the QKD appartus 1a starts connection authentication (the KM-QKD connection authentication or the like) required to be executed next in both a case where the connection authentication is indicated by the management system 3 and a case where the connection authentication is not indicated by the management system 3.

(3) The start unit 12 of the QKD appartus 1a enables the function of the QKD appartus 1a.

In a case where the QKD apparatus-management system connection authentication in steps S1 to S5 described above fails, the QKD appartus 1a (temporarily) stops the operation, and takes a measure such as making a notification of an abnormality by a log or an alarm.

Meanwhile, the management system 3 records the authentication result in a log or the like.

### KM-QKD Connection Authentication

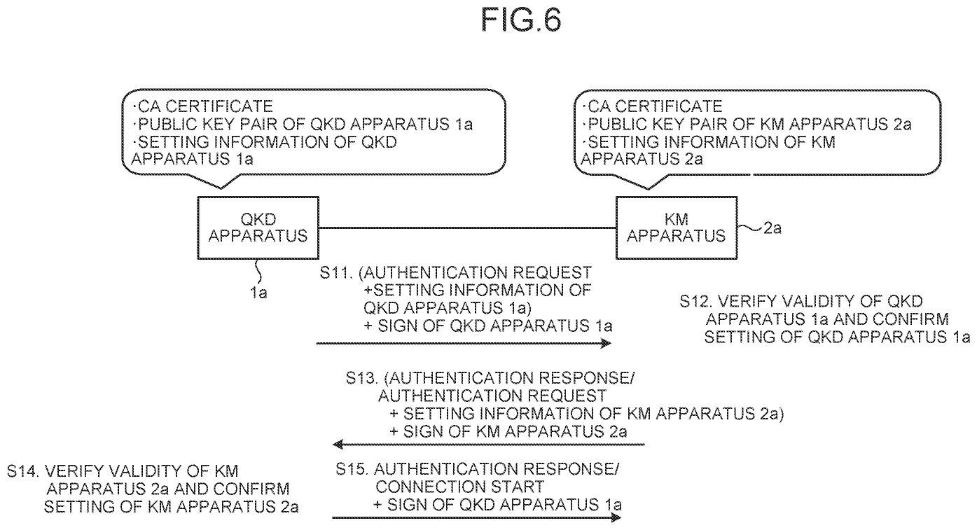

FIG. 6 is a sequence diagram illustrating an example of KM-QKD connection authentication according to the embodiment. The example of FIG. 6 illustrates a case of an authentication sequence executed between the QKD apparatus la and the KM apparatus 2a. It is assumed that the QKD appartus 1a holds a CA certificate, a public key/private key pair of the QKD appartus 1a, and setting information. It is assumed that the KM apparatus 2a holds a CA certificate, a public/private key pair of the KM apparatus 2a, and setting information.

First, the communication unit 14 of the QKD appartus 1a transmits an authentication request to the KM apparatus 2a (step S11). At this time, the authentication request may include the setting information of the QKD appartus 1a.

The setting information of the QKD appartus 1a includes the QKD protocol of the QKD appartus 1a, the mounting information, the manufacturer information, the customer ID information, the IP address setting, the installation position information, the operation parameter, the performance index, information of the opposing QKD apparatus 1b-1 that has the inter-QKD-apparatus connection, and the like. Examples of the information of the opposing QKD apparatus 1b-1 that has the inter-QKD-apparatus connection include ID information, address information, setting information, and the like of the opposing QKD apparatus 1b-1.

Note that the inter-QKD-apparatus connection with the opposing QKD apparatus 1b-1 may or does not have to be completed at the time of step S11.

As for the authentication result, if connection of the QKD appartus 1a to the QKD apparatus 1b-1 or the management system 3 has already been authenticated, authentication result information indicating the authentication may be added to the authentication request.

In addition, an authentication request message may be added with sign information indicating that the authentication request is signed by the QKD appartus 1a and is not falsified and that it is guaranteed that the authentication request has been transmitted by the legitimate QKD appartus 1a.

Next, the KM apparatus 2a performs authentication of the QKD appartus 1a (step S12). For example, in the authentication in step S12, it is verified whether or not the QKD appartus 1a is a legitimate apparatus having a valid certificate. Further, for example, in the authentication in step S12, it is verified whether or not the setting of the QKD appartus 1a is allowed. Note that the KM apparatus 2a may hold the allowable setting information of the QKD appartus 1a in advance. In addition, for example, in the authentication in step S12, it is verified whether or not the QKD appartus 1a has completed authentication (for example, the inter-QKD-apparatus connection authentication or the like) to be completed in advance.

Further, for example, in the authentication in step S12, it is verified whether or not a QKD apparatus 1 that is a connection authentication destination of the QKD appartus 1a is the QKD apparatus 1b-1. Note that it may also be separately verified whether or not the above-described “quadrangular relationship” can be confirmed with reference to the information held by the KM apparatus 2a. In a case where the normal “quadrangular relationship” is maintained, the QKD apparatus 1b-1 for which the QKD appartus 1a performs the inter-QKD-apparatus connection authentication performs the KM-QKD connection authentication with the KM apparatus 2b for which the KM apparatus 2a performs the inter-KM-apparatus connection authentication.

In addition, for example, in the authentication in step S12, since the setting information of the QKD appartus 1a also includes the performance index, whether or not the authentication can be performed may be determined based on the sufficiency of the performance of the QKD appartus 1a.

Note that along with the authentication in step S12, the KM apparatus 2a may perform authentication by communicating with an external apparatus (for example, the management system 3) as necessary.

Next, the KM apparatus 2a transmits an authentication response (the authentication processing result of step S12)/authentication request to the QKD appartus 1a (step S13). At this time, the authentication response/authentication request may include the setting information of the KM apparatus 2a.

The setting information of the KM apparatus 2a includes a KM protocol, mounting information, manufacturer information, customer ID information, IP address setting, installation position information, key storage capacity (for example, a current value and a maximum storage value), KM setting, connection application information, information (for example, an ID, setting, a sign, and the like) of the QKD apparatus (transmitter/receiver) that is in the KM-QKD connection relationship, information (for example, an ID, setting, a sign, and the like) of the KM apparatus 2b that is in the inter-KM-apparatus connection relationship, and the like.

The authentication response/authentication request may include setting information instructing the QKD appartus 1a to perform setting. The description of the setting information for instructing the QKD appartus 1a to perform setting is similar to that in FIG. 5, and thus is omitted.

In addition, an authentication response/authentication request message may be added with sign information indicating that the authentication response/authentication request is signed by the KM apparatus 2a and is not falsified and that it is guaranteed that the authentication response/authentication request has been transmitted by the legitimate KM apparatus 2a.

Next, the authentication processing unit 11 of the QKD appartus 1a performs authentication of the KM apparatus 2a (step S14). For example, in the authentication in step S14, it is verified whether or not the KM apparatus 2a is a legitimate apparatus having a valid certificate. Furthermore, for example, in the authentication in step S14, it is verified whether or not the setting of the KM apparatus 2a is allowable (whether or not network information (setting) of the KM apparatus 2a is appropriate).

The authentication processing unit 11 may perform the authentication in step S14 after verifying whether or not the setting information indicated by the KM apparatus 2a for the QKD appartus 1a is allowable. For example, the authentication processing unit 11 may reject the connection in a case where the KM protocol, the mounting information, the manufacturer information, or the customer ID information indicated by the KM apparatus 2a for the QKD appartus 1a is different.

Furthermore, for example, at the time of authentication in step S14, the authentication processing unit 11 may set again information regarding the amount and frequency of the cryptographic key provided from the QKD appartus 1a to the KM apparatus 2a in light of the information of the key storage capacity, or may reject the connection in light of the information of the key storage capacity. Further, at the time of authentication in step S14, the authentication processing unit 11 may verify whether or not the KM apparatus 2a has completed authentication (for example, the inter-KM-apparatus connection authentication) to be completed in advance.

Furthermore, for example, in the authentication in step S14, it is verified whether or not a KM apparatus 2 that is a connection authentication destination of the QKD appartus 1a is the KM apparatus 2a. Note that it may also be separately verified whether or not the above-described “quadrangular relationship” can be confirmed with reference to the information held by the QKD appartus 1a. For example, it may be verified whether or not the KM apparatus 2b connected to the opposing QKD apparatus 1b-1 and the KM apparatus 2b that has the inter-KM-apparatus connection with the opposing KM apparatus 2a are the same apparatus. For example, the authentication processing unit 11 verifies whether or not the KM apparatuses 2 are the same apparatus based on whether or not the IDs of the KM apparatuses 2 match.

Note that along with the authentication in step S14, the QKD appartus 1a may perform authentication by communicating with an external apparatus (for example, the management system 3) as necessary.

Next, the communication unit 14 of the QKD appartus 1a transmits an authentication completion notification (authentication response/connection start) to the KM apparatus 2a (step S15). An authentication completion notification (authentication response/connection start) message may be added with sign information indicating that the authentication request is signed by the QKD appartus 1a and is not falsified and that it is guaranteed that the authentication request has been transmitted by the legitimate QKD appartus 1a.

In a case where the KM-QKD connection authentication in steps S11 to S15 is successful, the QKD appartus 1a performs any one or more of the following processings (1) to (3).

(1) The QKD appartus 1a reflects the setting indicated by the KM apparatus 2a.

(2) The authentication processing unit 11 of the QKD appartus 1a starts connection authentication (the inter-QKD-apparatus connection authentication or the like) required to be executed next in both a case where the connection authentication is indicated by the KM apparatus 2a and a case where the connection authentication is not indicated by the KM apparatus 2a.

(3) The start unit 12 of the QKD appartus 1a enables the function of the QKD appartus 1a.

In a case where the KM-QKD connection authentication in steps S11 to S15 described above fails, the QKD appartus 1a (temporarily) stops the operation, and takes a measure such as making a notification of an abnormality by a log or an alarm.

On the other hand, in a case where the KM-QKD connection authentication is successful as a result of the authentication, the KM apparatus 2a performs any one or more of the following processings (1) to (3).

(1) The KM apparatus 2a reflects the setting indicated by the QKD appartus 1a.

(2) The KM apparatus 2a starts connection authentication (the inter-KM-apparatus connection authentication or the like) required to be executed next in both a case where the connection authentication is indicated by the QKD appartus 1a and a case where the connection authentication is not indicated by the QKD appartus 1a.

(3) The KM apparatus 2a enables the function of the KM apparatus 2a.

In a case where the authentication fails, the KM apparatus 2a (temporarily) stops the operation, and takes measures such as making a notification of an abnormality by a log or an alarm.

Inter-QKD-Apparatus Connection Authentication

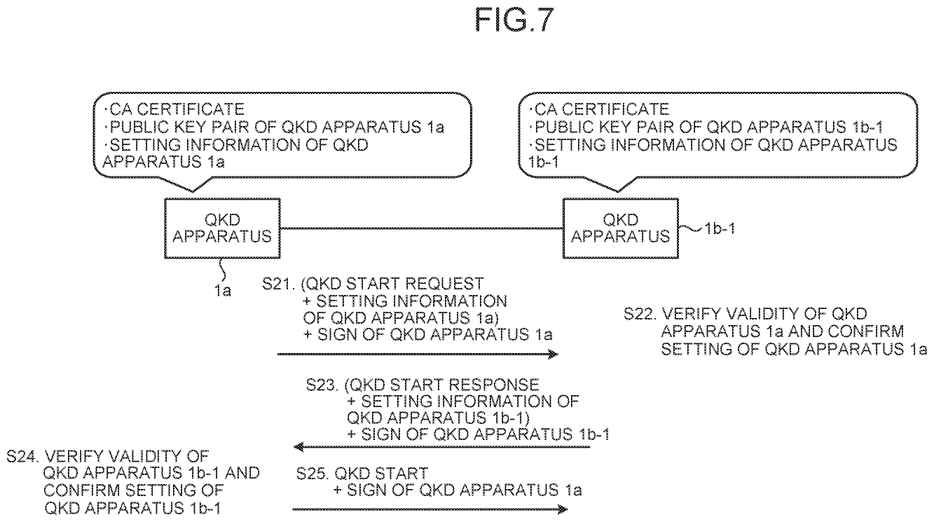

FIG. 7 is a sequence diagram illustrating a first example of the inter-QKD-apparatus connection authentication according to the embodiment. The first example of FIG. 7 illustrates a case of an authentication sequence executed between the QKD appartus 1a and the QKD apparatus 1b-1. It is assumed that the QKD appartus 1a holds a CA certificate, a public key/private key pair of the QKD appartus 1a, and setting information. It is assumed that the QKD apparatus 1b-1 holds a CA certificate, a public/private key pair of the QKD apparatus 1b-1, and setting information.

First, the communication unit 14 of the QKD appartus 1a transmits an authentication request (QKD start request) to the QKD apparatus 1b-1 (step S21). At this time, the authentication request may include the setting information of the QKD appartus 1a.

The setting information of the QKD appartus 1a includes the QKD protocol of the QKD appartus 1a, the mounting information, the manufacturer information, the customer ID information, the IP address setting, the installation position information, the operation parameter, the performance index, information of the KM apparatus 2a that is in the KM-QKD connection relationship, and the like. Examples of the information of the KM apparatus 2a that is in the KM-QKD connection relationship include ID information, address information, setting information, and the like of the KM apparatus 2a.

Note that the KM-QKD connection with the KM apparatus 2a may or does not have to be completed at the time of step S21.

As for the authentication result, if connection of the QKD appartus 1a to the KM apparatus 2a or the management system 3 has already been authenticated, authentication result information indicating the authentication may be added to the authentication request.

In addition, an authentication request message may be added with sign information indicating that the authentication request is signed by the QKD appartus 1a and is not falsified and that it is guaranteed that the authentication request has been transmitted by the legitimate QKD appartus 1a.

Next, the QKD apparatus 1b-1 performs authentication of the QKD appartus 1a (step S22). For example, in the authentication in step S22, it is verified whether or not the QKD appartus 1a is a legitimate apparatus having a valid certificate. Further, for example, in the authentication in step S22, it is verified whether or not the setting of the QKD appartus 1a is allowed. Note that the QKD apparatus 1b-1 may hold the allowable setting information of the QKD appartus 1a in advance. In addition, for example, in the authentication in step S22, it is verified whether or not the QKD appartus 1a has completed authentication (for example, the KM-QKD connection authentication or the like) to be completed in advance.

In addition, for example, in the authentication in step S22, it is verified whether or not the KM apparatus 2 that is a connection authentication destination of the QKD appartus 1a is the KM apparatus 2a (it may also be separately verified whether or not the above-described “quadrangular relationship” can be confirmed with reference to the information held by the QKD apparatus 1b-1). In a case where the normal “quadrangular relationship” is maintained, the KM apparatus 2a for which the QKD apparatus 1a performs the KM-QKD connection authentication performs the inter-KM-apparatus connection authentication with the KM apparatus 2b for which the QKD apparatus 1b-1 performs the inter-KM-apparatus connection authentication.

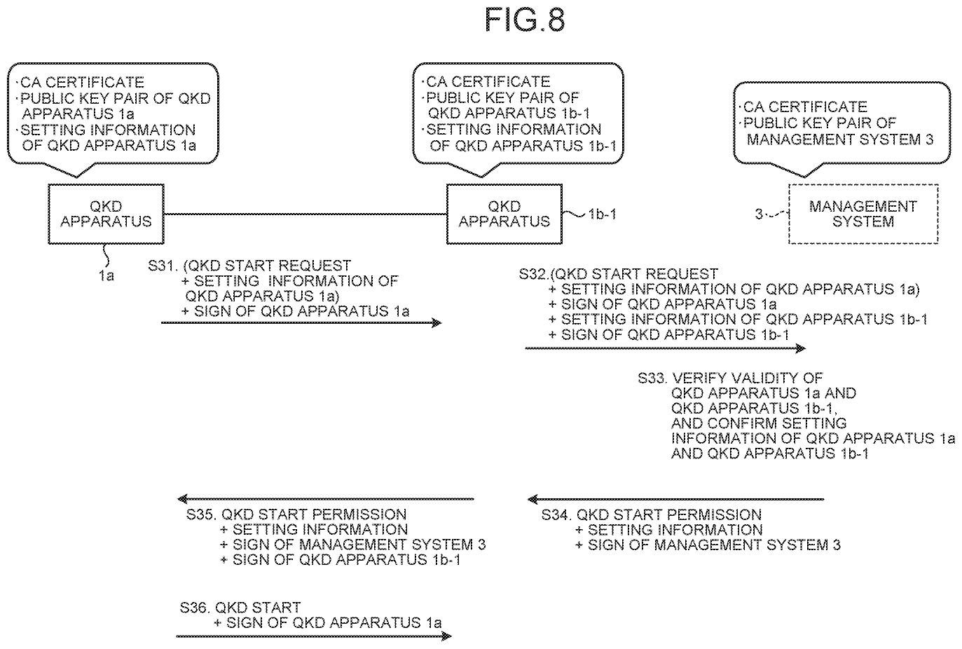

Note that along with the authentication in step S22, the QKD apparatus 1b-1 may perform authentication by communicating with an external apparatus (for example, the management system 3) as necessary. An example of the sequence in this case will be described later with reference to FIG. 8. A method in which an external apparatus (the management system 3 in FIG. 8) collectively manages a network configuration or authentication information between components has an advantage that the above-described “quadrangular relationship” or the like can be easily grasped.

Next, the QKD apparatus 1b-1 transmits a QKD start response (the authentication processing result/authentication request in step S22) to the QKD appartus 1a (step S23). At this time, the QKD start response may include the setting information of the QKD apparatus 1b-1. Since the setting information of the QKD apparatus 1b-1 is similar to the setting information of the QKD appartus 1a, a description thereof will be omitted. A QKD start response message may be added with sign information indicating that the authentication request is signed by the QKD apparatus 1b-1 and is not falsified and that it is guaranteed that the authentication request has been transmitted by the legitimate QKD apparatus 1b-1.

Next, the authentication processing unit 11 of the QKD appartus 1a performs authentication of the QKD apparatus 1b-1 (step S24). A description of step S24 is similar to the processing in which the QKD apparatus 1b-1 performs authentication of the QKD appartus 1a (step S22), and thus is omitted.

Next, the communication unit 14 of the QKD appartus 1a transmits a QKD start notification (authentication completion notification) to the QKD apparatus 1b-1 (step S25). A QKD start notification message may be added with sign information indicating that the authentication request is signed by the QKD apparatus la and is not falsified and that it is guaranteed that the authentication request has been transmitted by the legitimate QKD appartus 1a.

In a case where the inter-QKD-apparatus connection authentication in steps S21 to S25 is successful, the QKD appartus 1a performs any one or more of the following processings (1) to (3).

(1) The QKD appartus 1a reflects the setting indicated by the QKD apparatus 1b-1.

(2) The authentication processing unit 11 of the QKD appartus 1a starts connection authentication (the KM-QKD connection authentication or the like) required to be executed next in both a case where the connection authentication is indicated by the QKD apparatus 1b-1 and a case where the connection authentication is not indicated by the QKD apparatus 1b-1.

(3) The start unit 12 of the QKD appartus 1a enables the function of the QKD appartus 1a.

In a case where the inter-QKD-apparatus connection authentication in steps S21 to S25 described above fails, the QKD appartus 1a (temporarily) stops the operation, and takes a measure such as making a notification of an abnormality by a log or an alarm.

The operation of the QKD apparatus 1b-1 after the successful authentication and after the unsuccessful authentication is similar to that of the QKD appartus 1a.

Note that, in the authentication in step S22 described above, since the setting information of the QKD appartus 1a also includes, for example, the performance index such as a key distribution speed (key generation speed) assumed in the QKD appartus 1a, whether or not the authentication can be performed may be determined based on the sufficiency of the performance of the QKD appartus 1a. In a case of determining whether or not the authentication can be performed based on the sufficiency of the performance, specifically, in step S21, the communication unit 14 transmits a QKD start request including the QKD performance index to the opposing QKD apparatus 1b-1. The authentication processing unit 11 performs processing of verifying the validity of the QKD appartus 1a and whether or not the QKD performance index is satisfied in the authentication in step S22. Next, in the authentication in step S24, processing of verifying the validity of the opposing QKD apparatus 1b-1 is performed. Then, in a case where it is mutually verified that the QKD apparatuses 1a and 1b-1 are valid and the QKD performance index is satisfied, the authentication processing unit 11 determines that the inter-QKD-apparatus connection authentication is successful (step S25). Note that the processing of verifying whether or not the QKD performance index is satisfied may be performed on the QKD appartus 1a side in the authentication in step S24. In this case, the QKD appartus 1a receives the performance index of the QKD apparatus 1b-1 from the opposing QKD apparatus 1b-1.

FIG. 8 is a sequence diagram illustrating a second example of the inter-QKD-apparatus connection authentication according to the embodiment. The second example of FIG. 8 illustrates a case where authentication of the QKD apparatuses 1a and 1b-1 is performed by the management system 3 in step S33. A detailed description of the processing of each of steps S31 to S36 is similar to that of FIG. 7, and thus will be omitted.

As described above, in the QKD apparatus 1 according to the embodiment, the authentication processing unit 11 performs the inter-QKD-apparatus connection authentication indicating the authentication processing with the opposing QKD apparatus 1 and the KM-QKD connection authentication indicating the authentication processing with the opposing KM apparatus 2. Then, in a case where the inter-QKD-apparatus connection authentication is successful and the KM-QKD connection authentication is successful, the start unit 12 enables the QKD function.

As a result, with the QKD apparatus 1 according to the embodiment, the security of the QKD system 100 can be further improved.

Finally, an example of a hardware configuration of the QKD apparatus 1 according to the embodiment will be described.

### Example of Hardware Configuration

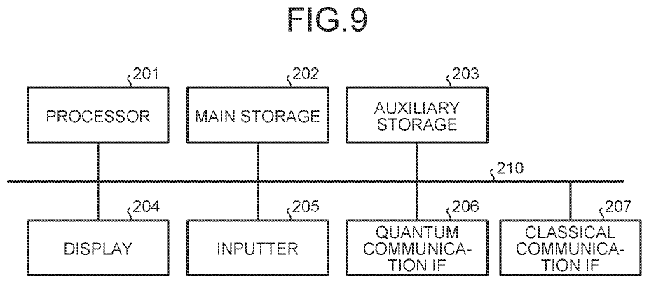

FIG. 9 is a diagram illustrating an example of the hardware configuration of the QKD apparatus 1 according to the embodiment. The QKD apparatus 1 according to the embodiment includes a processor 201, a main storage 202, an auxiliary storage 203, a display 204, an inputter 205, a quantum communication IF 206, and a classical communication IF 207. The processor 201, the main storage 202, the auxiliary storage 203, the display 204, the inputter 205, the quantum communication IF 206, and the classical communication IF 207 are connected via a bus 210.

The processor 201 executes a program read from the auxiliary storage 203 to the main storage 202. The main storage 202 is a memory such as a read only memory (ROM) and a random access memory (RAM). The auxiliary storage 203 is a hard disk drive (HDD), a memory card, or the like.

The display 204 displays the state and the like of the QKD apparatus 1. The inputter 205 receives an input from the user. Note that the QKD apparatus 1 does not have to include the display 204 and the inputter 205.

The quantum communication IF 206 is an interface for connection to a quantum cryptographic communication path (optical fiber link). The classical communication IF 207 is an interface for connection to a QKD control signal communication path, the KM apparatus 2, and the like. In a case where the QKD apparatus 1 does not include the display 204 and the inputter 205, for example, a display function and an input function of an external terminal connected via the classical communication IF 207 may be used.

The program executed by the QKD apparatus 1 is an installable or executable file, is stored in a computer-readable storage medium such as a CD-ROM, a memory card, a CD-R, or a digital versatile disc (DVD), and is provided as a computer program product.

Further, the program executed by the QKD apparatus 1 may be stored in a computer connected to a network such as the Internet and may be provided by being downloaded via the network.

Alternatively, the program executed by the QKD apparatus 1 may be provided via a network such as the Internet without being downloaded.

Further, the program executed by the QKD apparatus 1 may be provided by being incorporated in a ROM or the like in advance.

The program executed by the QKD apparatus 1 has a module configuration having a function that can be realized by the program among the functional configurations of the QKD apparatus 1 described above. The processor 201 reads the program from the storage medium such as the auxiliary storage 203 and executes the program, whereby the function realized by the program is loaded to the main storage 202. That is, the function realized by the program is generated on the main storage 202.

Some or all of the functions of the QKD apparatus 1 may be realized by hardware such as an integrated circuit (IC). The IC is, for example, a processor that performs dedicated processing.

Further, in a case of implementing the respective functions using a plurality of processors, each processor may implement one of the functions, or may implement two or more of the functions.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A quantum key distribution (QKD) apparatus comprising one or more hardware processors configured to:
perform inter-QKD-apparatus connection authentication indicating authentication processing with an opposing QKD apparatus, and key manager (KM)-QKD connection authentication indicating authentication processing with an opposing KM apparatus; and
enable a QKD function in a case where the inter-QKD-apparatus connection authentication is successful and the KM-QKD connection authentication is successful.

2. The apparatus according to claim 1, further comprising a communication interface, wherein
the one or more hardware processors are further configured to cause the communication interface to transmit, to a management system that manages a QKD system, a request for QKD apparatus-management system connection authentication indicating authentication processing with the management system, in a case where the inter-QKD-apparatus connection authentication is successful and the KM-QKD connection authentication is successful, and
the one or more hardware processors are configured to enable the QKD function in a case where it is mutually verified that the QKD apparatus is valid and the management system is valid by the QKD apparatus-management system connection authentication.

3. The apparatus according to claim 1, further comprising a communication interface, wherein
the one or more hardware processors are further configured to cause the communication interface to transmit, to a management system that manages a QKD system, a request for QKD apparatus-management system connection authentication indicating authentication processing with the management system,
the one or more hardware processors are configured to perform the inter-QKD-apparatus connection authentication and the KM-QKD connection authentication in a case where the QKD apparatus-management system connection authentication is successful.

4. The apparatus according to claim 1,
wherein the KM-QKD connection authentication includes processing of verifying whether or not a KM apparatus connected to the opposing QKD apparatus and a KM apparatus that has an inter-KM-apparatus connection to the opposing KM apparatus are identical.

5. The apparatus according to claim 1,
wherein the QKD function includes at least one of a function of generating a cryptographic key by QKD and a function of providing the cryptographic key to the KM apparatus.

6. The apparatus according to claim 1, further comprising a communication interface, wherein
the one or more hardware processors are further configured to cause the communication interface to transmit, to the opposing QKD apparatus, a QKD start request indicating a request for the inter-QKD-apparatus connection authentication,
the QKD start request includes a QKD performance index,
the inter-QKD-apparatus connection authentication includes processing of mutually verifying validity of the QKD apparatus and validity of the opposing QKD apparatus, and processing of verifying whether or not the QKD performance index is satisfied, and
the one or more hardware processors are configured to determine that the inter-QKD-apparatus connection authentication is successful in a case where the validity of the QKD apparatus and the validity of the opposing QKD apparatus are mutually verified and the QKD performance index is satisfied.

7. The apparatus according to claim 1, further comprising a communication interface, wherein
the one or more hardware processors are further configured to
generate a cryptographic key by QKD with the opposing QKD apparatus verified to be valid by the inter-QKD-apparatus connection authentication; and
cause the communication interface to provide the cryptographic key to the opposing KM apparatus verified to be valid by the KM-QKD connection authentication.

8. A quantum key distribution (QKD) system comprising:
a plurality of QKD apparatuses; and
a plurality of key manager (KM) apparatuses, wherein each of the plurality of QKD apparatuses includes:
one or more hardware processors configured to:
perform inter-QKD-apparatus connection authentication indicating authentication processing with an opposing QKD apparatus, and KM-QKD connection authentication indicating authentication processing with an opposing KM apparatus; and
enable a QKD function in a case where the inter-QKD-apparatus connection authentication is successful and the KM-QKD connection authentication is successful.

9. A quantum key distribution (QKD) start control method comprising:
performing, by a QKD apparatus, inter-QKD-apparatus connection authentication indicating authentication processing with an opposing QKD apparatus, and key manager (KM)-QKD connection authentication indicating authentication processing with an opposing KM apparatus; and
enabling, by the QKD apparatus, a QKD function in a case where the inter-QKD-apparatus connection authentication is successful and the KM-QKD connection authentication is successful.

10. A program product comprising a non-transitory computer-readable medium including programmed instructions, the instructions causing a computer of a quantum key distribution (QKD) apparatus to function as:
an authentication processing unit that performs inter-QKD-apparatus connection authentication indicating authentication processing with an opposing QKD apparatus, and key manager (KM)-QKD connection authentication indicating authentication processing with an opposing KM apparatus; and
a start unit that enables a QKD function in a case where the inter-QKD-apparatus connection authentication is successful and the KM-QKD connection authentication is successful.
